(19) United States
(12) Patent Application Publication
(10) Pub. No.: US 2026/0204593 A1
(43) Pub. Date: Jul. 16, 2026

(54) BIPOLAR PLATE ASSEMBLY FOR ELECTROLYSIS CELL

(71) Applicant: GM GLOBAL TECHNOLOGY OPERATIONS LLC, Detroit, MI (US)

(72) Inventors: Swaminatha P. Kumaraguru, Rochester Hills, MI (US); Yeh-Hung Lai, Oakland, MI (US); Mahesh Biradar, Auburn Hills, MI (US); Andy Roemer, Pomfret Center, CT (US); Luke Dalton, Cromwell, CT (US); Allyssa Murphy, Monroe, CT (US)

(21) Appl. No.: 19/019,829

(22) Filed: Jan. 14, 2025

(51) Int. Cl. H01M 4/86; H01M 4/88

(52) U.S. Cl. CPC H01M 4/8631; H01M 4/88; H01M 2004/8694

(57) ABSTRACT

Aspects of the disclosure include a bipolar plate assembly for an electrolysis cell (electrolyzer). An exemplary bipolar plate assembly for an electrolyzer includes an anode half plate having one or more intake headers, an anode-side flow field coupled to the one or more intake headers, and one or more outtake headers coupled to the anode-side flow field. The anode-side flow field is a dimple flow field having a series of dimples. The bipolar plate assembly further includes a cathode half plate coupled to the anode half plate, the cathode half plate having one or more outtake headers and a cathode-side flow field coupled to the one or more outtake headers. The cathode-side flow field is a land channel flow field having alternating lands and channels.

### INTRODUCTION

The present disclosure relates to hydrogen fuel cells and electrolysis, and particularly to a bipolar plate assembly for electrolysis cells.

Hydrogen fuel cells and related technologies have emerged as a promising clean energy solution, offering high efficiency and zero emissions for various applications ranging from transportation (e.g., personal and commercial vehicles, shipping, aircraft, etc.) to stationary power generation. In a hydrogen fuel cell, hydrogen enters through an anode, where it's split into protons and electrons. The protons pass through an electrolyte membrane, while electrons flow through an external circuit, generating electricity. At the cathode, protons, electrons, and oxygen combine to produce water. Hydrogen fuel cells are typically implemented in fuel cell stacks—assemblies of multiple individual hydrogen fuel cells connected in series to increase overall voltage and power output.

Hydrogen fuel cells require a supply of hydrogen fuel that is typically provided via one or more electrolysis cells. An electrolysis cell is a device that uses electrical energy to drive a non-spontaneous chemical reaction that splits water (H₂O) into hydrogen (H₂) and oxygen (O₂) gases. An electrolysis cell typically includes of an anode, a cathode, and an electrolyte. When an electric current is applied between the anode and cathode, water molecules are split at the anode to produce oxygen gas and protons (H⁺), while at the cathode, protons combine with electrons to produce hydrogen gas.

### SUMMARY

In one exemplary embodiment a bipolar plate assembly for an electrolyzer includes an anode half plate having one or more anode-side intake headers, an anode-side flow field coupled to the one or more anode-side intake headers, and one or more anode-side outtake headers coupled to the anode-side flow field. The anode-side flow field is a dimple flow field having a series of dimples. The bipolar plate assembly further includes a cathode half plate coupled to the anode half plate, the cathode half plate having a cathode-side flow field and one or more cathode-side outtake headers coupled to the cathode-side flow field. The cathode-side flow field is a land channel flow field having alternating lands and channels.

In some embodiments, the anode half plate and the cathode half plate are assembled asymmetrically such that a fluid flow in the anode half plate is rotated 90 degrees relative to a fluid flow in the cathode half plate.

In some embodiments, the anode half plate and the cathode half plate collectively define a single separator plate of the electrolyzer.

In some embodiments, the anode half plate and the cathode half plate have a same thickness.

In some embodiments, the anode half plate has a first thickness and the cathode half plate has a second thickness less than the first thickness.

In some embodiments, the intake headers and outtake headers of the anode half plate and the outtake headers of the cathode half plate are sealed from the anode-side flow field and the cathode-side flow field.

In some embodiments, anode-side tunnels couple the anode-side intake headers and the anode-side outtake headers, respectively, to the anode-side flow field.

In some embodiments, cathode-side tunnels couple the cathode-side outtake headers to the cathode-side flow field.

In some embodiments, the cathode half plate and the anode half plate are coupled via a symmetric metal bead configuration.

In some embodiments, the cathode half plate includes a first metal bead height and the anode half plate includes a second metal bead height different than the first metal bead height.

In some embodiments, the intake and outtake headers of cathode half plate and anode half plate are sealed using an elastomer bead.

In yet another exemplary embodiment a method can include forming an anode half plate having one or more anode-side intake headers, an anode-side flow field coupled to the one or more anode-side intake headers, and one or more anode-side outtake headers coupled to the anode-side flow field. The anode-side flow field is a dimple flow field having a series of dimples. The method further includes forming a cathode half plate coupled to the anode half plate, the cathode half plate having a cathode-side flow field and one or more cathode-side outtake headers coupled to the cathode-side flow field. The cathode-side flow field is a land channel flow field having alternating lands and channels.

In some embodiments, the anode half plate and the cathode half plate are assembled asymmetrically such that a fluid flow in the anode half plate is rotated 90 degrees relative to a fluid flow in the cathode half plate.

In some embodiments, the anode half plate and the cathode half plate collectively define a single separator plate of the electrolyzer.

In some embodiments, the anode half plate and the cathode half plate have a same thickness.

In some embodiments, the anode half plate has a first thickness and the cathode half plate has a second thickness less than the first thickness.

In some embodiments, the intake headers and outtake headers of the anode half plate and the outtake headers of the cathode half plate are sealed from the anode-side flow field and the cathode-side flow field.

In some embodiments, anode-side tunnels couple the anode-side intake headers and the anode-side outtake headers, respectively, to the anode-side flow field.

In some embodiments, cathode-side tunnels couple the cathode-side outtake headers to the cathode-side flow field.

In some embodiments, the cathode half plate and the anode half plate are coupled via a symmetric metal bead configuration.

In some embodiments, the cathode half plate includes a first metal bead height and the anode half plate includes a second metal bead height different than the first metal bead height.

In some embodiments, the intake and outtake headers of cathode half plate and anode half plate are sealed using an elastomer bead.

In some embodiments, the method further includes forming bead shape protrusions around the anode side intake headers and anode side outtake headers forming seals to restrict fluid flow.

In some embodiments, the method further includes forming bead shape protrusions around the cathode side outtake headers forming seals to restrict fluid flow.

In some embodiments, the method further includes application of a thin elastomeric materials on the bead shape protrusion of anode and cathode half plate.

In some embodiments, the method further includes aligning the bead shape protrusions of anode half side and cathode half side plates to provide sealing function.

In some embodiments, the method further includes forming bead shape on anode side and cathode side at different heights to form asymmetric bead seal.

In some embodiments, the method further includes forming bead shape seal feature on anode side and cathode side with elastomer material only.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 depicts a simplified cross-sectional view of a membrane electrode assembly (MEA) layer of an electrolyzer in accordance with one or more embodiments;

FIG. 2 is an anode half plate in accordance with one or more embodiments;

FIG. 3 is a cathode half plate in accordance with one or more embodiments;

FIG. 4 depicts an electrolysis cell (e.g., an electrolyzer) in accordance with one or more embodiments;

FIG. 5A depicts a cross-sectional view of a bipolar plate having a symmetric metal bead configuration in accordance with one or more embodiments;

FIG. 5B depicts a cross-sectional view of a bipolar plate having an asymmetric metal bead configuration in accordance with one or more embodiments;

FIG. 5C depicts a cross-sectional view of region A-A of the anode half plate of FIG. 2 in accordance with one or more embodiments;

FIG. 6. is a computer system according to one or more embodiments; and

FIG. 7 is a flowchart in accordance with one or more embodiments.

### DETAILED DESCRIPTION

The following description is merely exemplary in nature and is not intended to limit the present disclosure, its application or uses.

Understanding and optimizing hydrogen fuel cells and their various support systems, such as electrolysis cells (also referred to as electrolyzers), has become desired for widespread adoption and commercialization of hydrogen fuel cell technologies. One of the key components in both hydrogen fuel cells and electrolysis cells is the bipolar plate (BPP). In fuel cell stacks, BPPs serve multiple functions such as distributing reactant gases, removing reaction products, conducting electrical current between cells, and providing mechanical support. Similarly, in the context of electrolysis cells, BPPs separate the anode and cathode compartments, distribute water and gases, conduct electrical current, and provide mechanical support to the various headers, channels, and flow fields which make up an electrolysis cell.

As research into hydrogen fuel cell technology advances, optimizing BPP design will continue to be a driver in improving overall performance and durability. Unfortunately, improvements in bipolar plate designs have been somewhat limited. For example, since electrolyzer applications do not need a coolant path, common electrolyzer plates are typically made from a single separator plate and the gas paths between the intake headers and flow fields (active areas) is largely made through modified plastic frames and/or over-molded designs. In short, these methods generally involve adding plastic components to metal separator plates to form channels and pathways for gas flow. The use of different materials (metal and plastic) can lead to issues with thermal expansion and chemical compatibility, potentially causing degradation over time. Moreover, ensuring a reliable seal between plastic frames and metal plates is difficult, and any imperfections in the seal can lead to gas or fluid leaks, reducing the efficiency and performance of the electrolyzer. Overall, this approach leads to complexity in Unitized Electrode Assembly (UEA) design and reduced component lifespans.

This disclosure introduces a bipolar plate assembly for electrolysis cells. Rather than relying upon a single separate plate, electrolysis cells described herein are fabricated from separate anode half plates and cathode half plates that are welded together or bonded via a conductive adhesive or brazing to form a bipolar plate assembly. Advantageously, the half plates in this type of configuration can be uniquely designed to support their specific electrochemical functions. In particular, the anode flow field (FF) can be constructed in a dimple flow field configuration to achieve an increased or maximum water flow with a relatively low pressure drop. Conversely, the cathode flow field can be constructed with land channel patterns. Other advantages are possible. For example, in some embodiments, the headers in the respective anode and cathode half plates can be positioned asymmetrically to provide a relative less complex sealing of anode and cathode flows, respectively. In addition, the use of a two-half plate design enables tunnels for flow from the header to the flow field active areas.

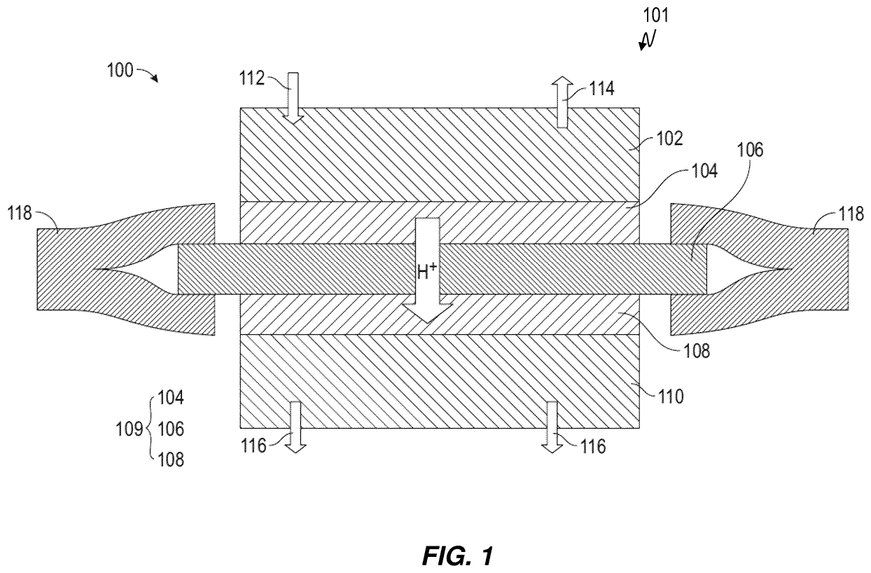

FIG. 1 depicts a simplified cross-sectional view of a membrane electrode assembly (MEA) layer 101 of an electrolyzer 100 in accordance with one or more embodiments. As shown in FIG. 1, electrolyzer 100 includes a porous transport layer (PTL) 102, a proton-generating electrode 104 (also referred to as an anode or as an H⁺ generating electrode), membrane 106, a proton-consuming electrode 108 (also referred to as a cathode or as an H⁺ consuming electrode), and a gas diffusion layer (GDL) 110 (sometimes referred to as a diffusion media, or DM), configured and arranged as shown. In this configuration, protons (H⁺) are generated at the interface between the proton-generating electrode 104 and the membrane 106 and are passed through to the proton-consuming electrode 108. In some embodiments, the proton-generating electrode 104 and proton-consuming electrode 108 are coupled to a power source (not separately indicated) which supplies a current across the anode and cathode so that water fed to the electrolyzer 100 can be split into hydrogen and oxygen. The combination of proton-generating electrode 104, membrane 106, and proton-consuming electrode 108 together define a membrane electrode assembly (MEA) 109.

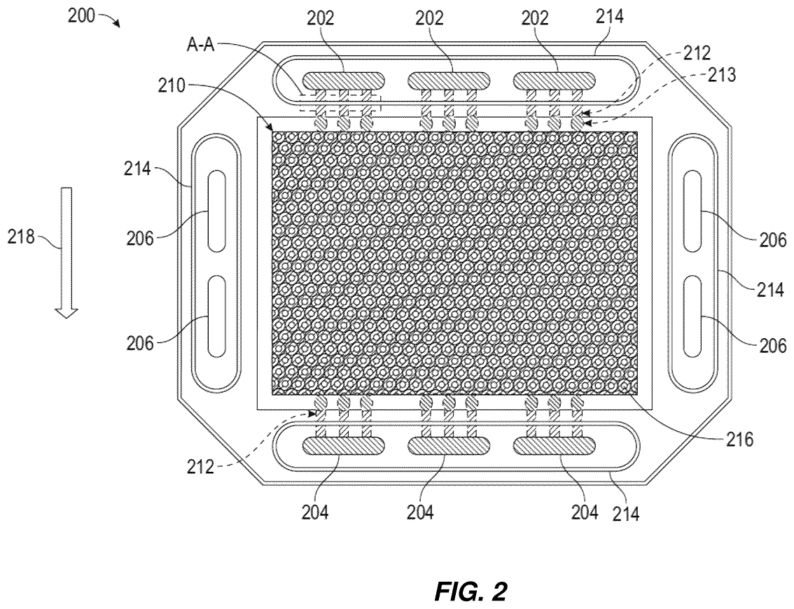

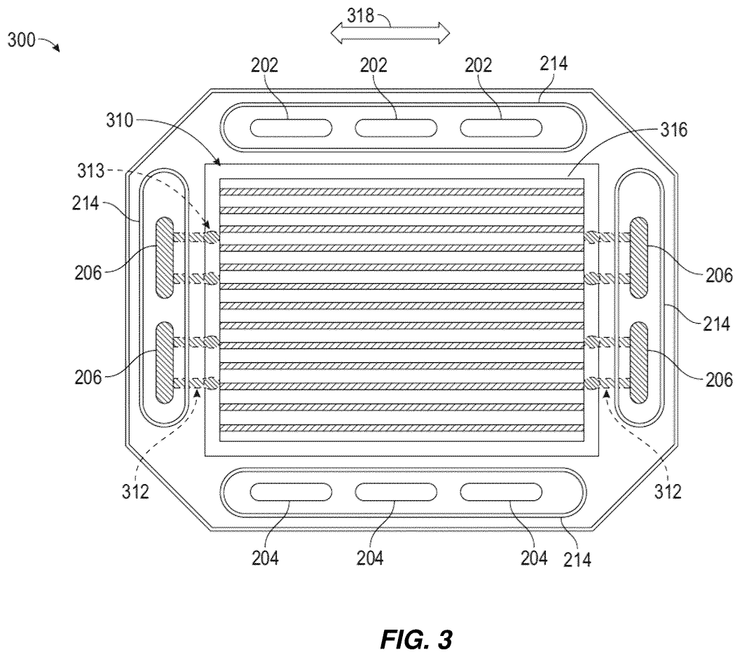

In some embodiments, PTL 102 facilitates a uniform distribution of reactant fluids, typically water, across the proton-generating electrode 104 and to membrane 106. PTL 102 also facilitates the efficient removal of by-products such as oxygen gas from electrolyzer 100. In some embodiments, PTL 102 is made of materials that offer a combination of high electrical conductivity, chemical stability, mechanical strength, and porosity, such as, for example, sintered titanium, stainless steel, carbon-based materials such as carbon paper and carbon cloth, and nickel-based materials such as nickel foam. It should be appreciated that while embodiments herein illustrate the PTL 102 as being a single component, in other embodiments the PTL 102 may comprise a plurality of layers or components. The porous structure of the PTL 102 allows for uniform distribution of water across the active area (refer to FIGS. 2 and 3) of the MEA 109, enhancing the electrochemical reactions therein. Additionally, the PTL 102 provides electrical conductivity and mechanical support to electrolyzer 100. In some embodiments, the PTL 102 supports the membrane 106 against a pressure differential between the anode and cathode sides of the cell. In some embodiments, a first side (not separately indicated) of PTL 102 is faced against the anode-side flow field 210 (refer to FIG. 2). Reactant fluids 112 (e.g., water) enters MEA layer 101 and fluids 114 (e.g., unspent reactant fluids along with product oxygen generated from electrochemical reactions within) leaves MEA layer 101.

In some embodiments, the proton-generating electrode 104 is positioned directly beneath the PTL 102 and between PTL 102 and membrane 106. The proton-generating electrode 104 is responsible for the oxidation of water molecules during the electrolysis process, producing oxygen gas, protons (H⁺), and electrons. The protons generated at the proton-generating electrode 104 pass through the membrane 106 to the proton-consuming electrode 108, while the electrons flow through an external circuit (not separately shown). The proton-generating electrode 104 is designed to facilitate efficient electrochemical reactions, ensuring desired hydrogen production and can be coupled with the PTL 102 to ensure uniform distribution of water and the effective removal of oxygen gas.

In some embodiments, MEA 109 is positioned between the PTL 102 and GDL 110. MEA 109 is the core functional unit of the electrolyzer 100 and denotes the active areas (anode-side flow field 210 and cathode-side flow field 310, refer to FIGS. 2 and 3) where the primary electrochemical reactions occur, converting electrical energy into chemical energy by splitting water into hydrogen and oxygen gases. The MEA 109 includes several layers, including a proton exchange membrane (PEM, e.g., membrane 106), an anode catalyst layer (e.g., proton-generating electrode 104), and a cathode catalyst layer (e.g., proton-consuming electrode 108). The PEM is a solid polymer electrolyte that conducts protons (H⁺) while acting as an insulator for electrons, ensuring that the protons generated at the anode can pass through to the cathode while preventing the mixing of reactant gases. The catalyst layers are attached on both sides of the PEM and may contain finely divided catalytic particles, such as platinum (Pt), supported on carbon particles. These catalyst layers facilitate the electrochemical reactions: at the anode, water molecules are oxidized to produce oxygen gas, protons, and electrons, while at the cathode, protons and electrons combine to form hydrogen gas. More specifically, the proton-generating electrode 104 is sandwiched between membrane 106 and PTL 102 and contains finely divided catalyst particles such as iridium (Ir) and/or titanium oxide particles. On the other hand, the proton-consuming electrode 108 is sandwiched between membrane 106 and GDL 110 and contains finely divided catalyst particles such as platinum (Pt), supported by carbon particles. The catalyst layers can be coated on the membrane 106, coated on the PTL 102, coated on the GDL 110, and/or decal transferred to any or all of membrane 106, PTL 102, and GDL 110.

In some embodiments, the proton-consuming electrode 108 is positioned directly beneath the membrane 106 and between membrane 106 and GDL 110. The proton-consuming electrode 108 is responsible for the reduction of protons (H⁺) and electrons to form hydrogen gas during the electrolysis process. The proton-consuming electrode 108 facilitates the efficient combination of protons, which have passed through the membrane 106 from the proton-generating electrode 104, with electrons that have traveled through an external circuit (e.g., a power source, not separately indicated). The proton-consuming electrode 108 is designed to facilitate efficient electrochemical reactions, ensuring desired hydrogen reduction and can be coupled with the GDL 110 to ensure a uniform removal of hydrogen gas from the electrolyzer 100.

In some embodiments, GDL 110 is a porous material such as carbon fiber paper or cloth that facilitates a uniform evacuation of hydrogen gas from MEA 109. In some embodiments, a first side (not separately indicated) of GDL 110 is faced against the cathode-side flow field 310 (refer FIG. 3) to facilitate the exit of reactants and byproducts 116, typically hydrogen gas. It should be appreciated that while the illustrated embodiment shows the GDL 110 as being a single component, in other embodiments the GDL may comprise a plurality of layers or components.

A subgasket 118 encapsulates the periphery of the MEA 109 and extends to inactive regions of the electrolyzer 100 (that is, the various headers, seals, etc., of the anode half plate 200, cathode half plate 300, and MEA layer 101 in FIGS. 2, 3, and 4, respectively).

FIG. 2 depicts an anode half plate 200 of a bipolar plate assembly for an electrolyzer (e.g., electrolyzer 100 of FIG. 1) in accordance with one or more embodiments. As shown in FIG. 2, anode half plate 200 includes one or more anode-side intake headers 202, one or more anode-side outtake headers 204, one or more cathode-side outtake headers 206 (refer to FIG. 3), and an anode-side flow field 210, configured and arranged as shown. While not meant to be particularly limited, the various components of the anode half plate 200 can be formed using techniques such as, for example, hydroforming, stamping, machining, and/or chemical and electrochemical etching.

The anode-side intake headers 202 serve as the entry point(s) to the anode half plate 200 for reactant fluid, typically water, which is used in the electrochemical reactions occurring within the anode-side flow field 210 (the anode active area). The primary function of an anode-side intake header 202 is to distribute the incoming reactant fluid (water) uniformly across the anode-side flow field 210. This ensures that water is evenly supplied to the active area where the electrochemical reaction takes place, leading to efficient hydrogen production. In some embodiments, the anode-side intake headers 202 are arranged symmetrically and/or with even spacing (centerline-to-centerline pitch) to evenly distribute fluids to the anode-side flow field 210.

The anode-side outtake headers 204 serve as the exit point(s) from the anode half plate 200 for reactant fluid and any by-products generated during the electrochemical reactions occurring within the anode-side flow field 210 (the anode active area). The primary function of an anode-side outtake header 204 is to collect and remove the reactant fluid (water) and any by-products (such as oxygen gas) from the anode-side flow field 210 after the electrochemical reactions have occurred. This ensures that the spent fluid and gases are efficiently evacuated from the active area, reducing or preventing any buildup that could hinder the efficiency of the electrolysis process. In some embodiments, the anode-side outtake headers 204 are arranged symmetrically and/or with even spacing (centerline-to-centerline pitch) to evenly distribute fluids to the anode-side flow field 210.

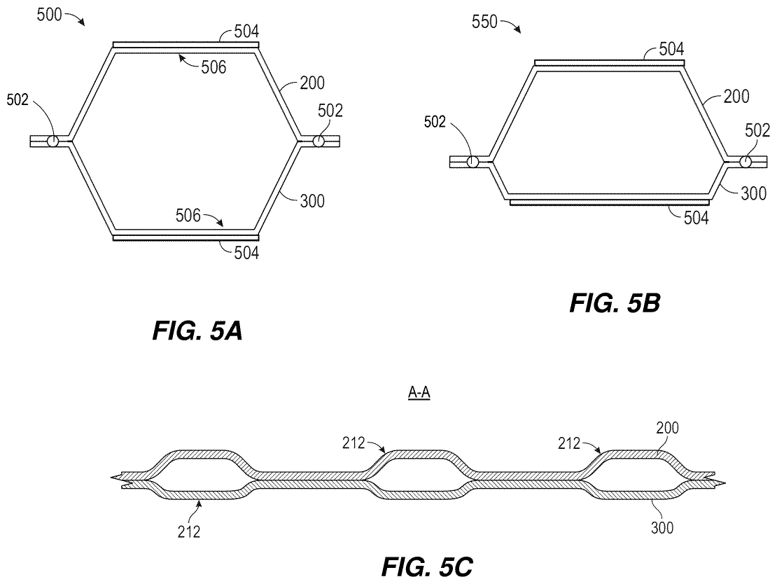

As further shown in FIG. 2, in some embodiments, the headers (e.g., anode-side intake headers 202 and/or anode-side outtake headers 204) are coupled to a series of anode-side fluid passages 212 coupling the anode-side intake headers 202 and the anode-side outtake headers 204, respectively, to the anode-side flow field 210. In some embodiments, headers 202, 204 will be sealed, and fluid (e.g., hydrogen, water, etc.) cannot go directly from the headers 202, 204 to the anode-side flow field 210 over the respective plate or seal. In some embodiments, the anode-side fluid passages 212 on the anode half plate 200, when faced against cathode-side channels (or flat plate) of the cathode half plate 300 (refer to FIG. 3) form a passage between the respective plates (refer to FIG. 5C). In other words, in some embodiments, fluid from the headers 202, 204 would enter through respective fluid passages 212 and would exit into the anode-side flow field 210 through apertures or openings 213. In some embodiments, fluid passages 212 are designed and positioned to reduce or minimize pressure losses and ensure uniform flow distribution. While not meant to be particularly limited, various techniques can be employed to reduce or minimize pressure losses and ensure uniform flow distribution, such as, for example, fluid passage geometry design, fluid passage layout, and fluid passage positioning. Fluid passage geometry design includes selecting the cross-sectional shape and/or aspect ratio of the fluid passages 212. Fluid passage with a smooth, rounded cross-sectional shape (e.g., circular or elliptical) tend to have lower pressure losses as compared to sharp-edged or rectangular fluid passages as a smooth shape reduces turbulence and frictional losses. The aspect ratio (width-to-height ratio) of the fluid passages 212 should be optimized to balance flow resistance and structural integrity. Fluid passages that are too narrow may increase pressure losses, while fluid passages that are too wide may compromise the mechanical strength of the plate. In an embodiment, the fluid passage layout can also be optimized, and can include the selection of parallel fluid passages and/or branching fluid passages for fluid distribution. Fluid passages 212 can be arranged in a parallel configuration to distribute fluids evenly. In some embodiments, each fluid passage 212 arranged in parallel has a same or similar (within tooling limits) length and cross-sectional area to ensure uniform flow rates. Conversely, or in addition, fluid passages 212 can be arranged in a branching pattern, such as a tree-like or fractal design. These patterns divide the flow into smaller streams, ensuring that the fluid reaches all areas of the anode-side flow field 210. Fluid passage positioning refers to the relative positioning of the fluid passages 212 relative to the anode-side flow field 210 and headers (anode-side intake header 202 and anode-side outtake header 204). In some embodiments, fluid passages 212 can be positioned symmetrically around a central axis of the anode-side flow field 210 to ensure even distribution. Alternatively, in some embodiments, asymmetrical positioning can be leveraged to direct targeted flow volumes to any region within the anode-side flow field 210 (this approach can aid with pressure imbalances discovered empirically or during simulation, for example, using computational fluid dynamics (CFD) simulations). It should be understood that the fluid passage geometry design, layout, and positioning will vary depending on the needs of a given application. In some embodiments, CFD simulation tools can be used to improve or optimize these parameters.

In some embodiments, header seals 214 isolate the headers (e.g., anode-side intake headers 202, anode-side outtake headers 204, and/or cathode-side outtake headers 206) from the anode-side flow field 210. In some embodiments, the header seals 214 are metal bead seals (e.g., the symmetric metal bead configuration of bipolar plate 500 or the asymmetric metal bead configuration of bipolar plate 550, refer to FIGS. 5A and 5B), although other configurations, such as elastomer seals only (that is, without metal bead seals) on metal plates are possible, and all such configurations are within the contemplated scope of this disclosure. In some embodiments, the header seals 214 are formed over the anode-side fluid passages 212, thereby allowing flow between the headers and the anode-side flow field 210.

The anode-side flow field 210 is responsible for distributing reactant fluids (typically water) uniformly across the anode active area surface, facilitating efficient electrochemical reactions. In some embodiments, anode-side flow field 210 is configured as a dimple flow field for high efficiency fluid flow. In a dimple flow field configuration, the anode-side flow field 210 includes a series of dimples 216 or protrusions arranged in a regular pattern. The dimples 216 create localized turbulence, enhancing mass transfer and reducing pressure losses. This configuration is particularly effective for ensuring uniform distribution of the reactant fluid and efficient removal of oxygen gas.

FIG. 3 depicts a cathode half plate 300 in accordance with one or more embodiments. As shown in FIG. 3, cathode half plate 300 includes one or more anode-side intake headers 202 (refer to FIG. 2), one or more anode-side outtake headers 204 (refer to FIG. 2), one or more cathode-side outtake headers 206, and a cathode-side flow field 310, configured and arranged as shown. While not meant to be particularly limited, the various components of the cathode half plate 300 can be formed using techniques such as, for example, hydroforming, stamping, machining, and/or chemical and electrochemical etching.

The cathode-side outtake headers 206 serve as the exit point(s) from the cathode half plate 300 for hydrogen generated during electrochemical reactions occurring within the cathode-side flow field 310 (the cathode active area). The primary function of cathode-side outtake headers 206 is to collect and remove the hydrogen generated from the cathode-side flow field 310 after the electrochemical reactions have occurred as well as any anode side reactant fluid that was transported to the cathode-side flow field 310 via membrane diffusion. This ensures that the spent fluid and gases are efficiently evacuated from the active area, reducing or preventing any buildup that could hinder the efficiency of the electrolysis process. In some embodiments, the cathode-side outtake headers 206 are arranged symmetrically and/or with even spacing (centerline-to-centerline pitch) to evenly distribute fluids to the cathode-side flow field 310.

As further shown in FIG. 3, in some embodiments, the headers (e.g., cathode-side outtake headers 206) are coupled to a series of cathode-side fluid passages 312 coupling the cathode-side outtake headers 206 to the cathode-side flow field 310. In some embodiments, cathode-side outtake headers 206 will be sealed, and fluid (e.g., hydrogen) cannot go directly from the cathode-side outtake headers 206 to the cathode-side flow field 310 over the respective plate or seal. In some embodiments, the cathode-side fluid passages 312 on the cathode half plate 300, when faced against anode-side channels (or flat plate) of the anode half plate 200 (refer to FIG. 2) form a passage between the respective plates (refer to FIG. 5C). In other words, in some embodiments, fluid from the cathode-side outtake headers 206 would enter through respective fluid passages 312 and would exit into the cathode-side flow field 310 through apertures or openings 313. In some embodiments, fluid passages 312 are designed and positioned to reduce or minimize pressure losses and ensure uniform flow distribution, in a similar manner as previously described with respect to the fluid passages 212 (refer to FIG. 2).

Fluid passages 312 can be arranged in a parallel configuration to distribute fluids evenly. In some embodiments, each fluid passage 312 arranged in parallel has a same or similar (within tooling limits) length and cross-sectional area to ensure uniform flow rates. Conversely, or in addition, fluid passages 312 can be arranged in a branching pattern, such as a tree-like or fractal design. These patterns divide the flow into smaller streams, ensuring that the fluid reaches all areas of the cathode-side flow field 310. In some embodiments, fluid passages 312 can be positioned symmetrically around a central axis of the cathode-side flow field 310 to ensure even distribution. Alternatively, in some embodiments, asymmetrical positioning can be leveraged to direct targeted flow volumes to any region within the cathode-side flow field 310 (this approach can aid with pressure imbalances discovered empirically or during simulation, for example, using CFD simulations). It should be understood that the channel geometry design, channel layout, and channel positioning will vary depending on the needs of a given application. In some embodiments, CFD simulation tools can be used to improve or optimize these parameters.

In some embodiments, header seals 214 isolate the headers (e.g., anode-side intake headers 202, anode-side outtake headers 204, and/or cathode-side outtake headers 206) from the cathode-side flow field 310. In some embodiments, the header seals 214 are metal bead seals (refer to FIGS. 5A and 5B), although other configurations, such as elastomer seals on metal plates are possible, and all such configurations are within the contemplated scope of this disclosure. In some embodiments, the header seals 214 are formed over the cathode-side fluid passages 312, thereby allowing flow between the headers and the cathode-side flow field 310.

The cathode-side flow field 310 is responsible for distributing reactant and product fluids (hydrogen gas) uniformly across the cathode active area surface, facilitating efficient electrochemical reactions. In some embodiments, cathode-side flow field 310 is configured as a land channel flow field to reduce or minimize interfacial contact resistance and to reduce gas diffusion layer (GDL) intrusion. In a land channel configuration, the flow field is composed of alternating lands (raised areas) and channels (recessed areas). The lands provide direct mechanical support to the GDL (not separately indicated), preventing it from sagging or intruding into the channels. This structural support helps maintain the integrity and position of the GDL, reducing the risk of intrusion. In a land channel field configuration, the cathode-side flow field 310 includes land channels 316 which can be arranged in a wavy channel structure, straight channel structure (as shown in FIG. 3), or interdigitated channel structure, as desired.

Referring now to FIGS. 2 and 3, in some embodiments, the headers (e.g., anode-side intake headers 202 and anode-side outtake headers 204) of the anode half plate 200 and the headers (e.g., cathode-side outtake headers 206) of the cathode half plate 300 are assembled asymmetrically with fluid flow in the anode half plate 200 being 90° to fluid flow in the cathode half plate 300. For example, in the configuration shown in FIG. 2, the anode-side flow direction 218 moves anode-side fluids such as water in a first direction (as shown) between, successively, the anode-side intake headers 202, the anode-side flow field 210, and the anode-side outtake headers 204. Conversely, in the configuration shown in FIG. 3, the cathode-side flow direction 318 moves cathode-side fluids such as hydrogen gas in a second direction(s) orthogonal to the first direction (as shown, from within the cathode-side flow field 310 to the cathode-side outtake headers 206) between, successively, the cathode-side flow field 310 and the cathode-side outtake headers 206.

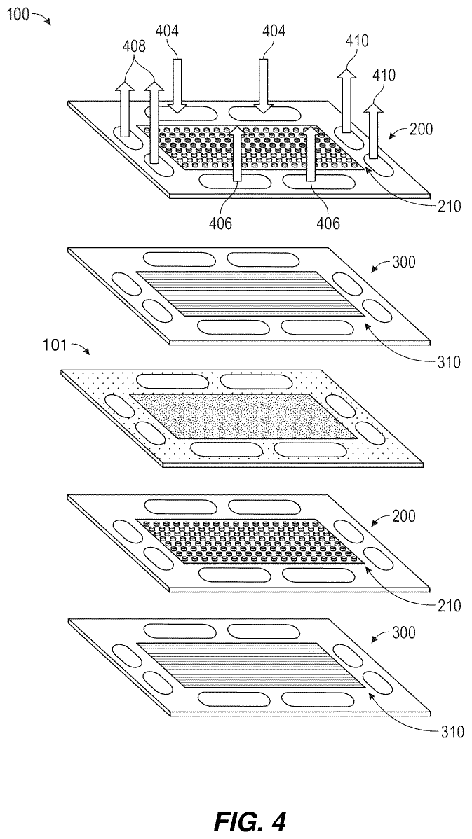

FIG. 4 depicts a view of electrolyzer 100 (also referred to as an electrolysis cell) in accordance with one or more embodiments. As shown in FIG. 4, electrolyzer 100 includes two anode half plates 200 and two cathode half plates 300 arranged in an alternating configuration as shown. Electrolyzer 100 further includes MEA layer 101 (also referred to as a gasketed MEA with GDL and PTL). In some embodiments, one anode half plate 200 and one cathode half plate 300 are paired on each side of the MEA layer 101. As further shown in FIG. 4, electrolyzer 100 includes a plurality of water inlets 404, a plurality of water outlets 406, and a plurality of hydrogen outlets 408 and 410 (refer to FIGS. 2 and 3). Observe that, advantageously, the flow fields of the anode half plates 200 are of the dimple flow field configuration while the flow fields of the cathode half plates 300 are of the land channel flow field configuration.

FIG. 5A depicts a cross-sectional view of a bipolar plate 500 having a symmetric metal bead configuration in accordance with one or more embodiments. FIG. 5B depicts a cross-sectional view of a bipolar plate 550 having an asymmetric metal bead configuration in accordance with one or more embodiments. As shown in FIGS. 5A and 5B, the bipolar plates 500, 550 can include an anode half plate 200 coupled to a cathode half plate 300 using one or more welds 502 in a symmetric metal bead seal and asymmetric metal bead seal configuration, respectively. Welds 502 can be supported by, or replaced by, other sealing mechanisms, such as, for example, the use of adhesives and/or brazing. Whether symmetric or asymmetric, a metal bead seal typically consists of raised metal ridges or beads (not separately indicated) that are integrated into the surface of the respective bipolar plates (e.g., the anode half plate 200 and/or cathode half plate 300). In some embodiments, a relatively thin (e.g., less than 150 microns, for example 50 to 130 microns) elastomer layer 504 can be attached on topmost and/or bottommost surface(s) 506 of the metal beads (not separately indicated) of the respective half-plates. The thin elastomer layer 504 can be made by screenprinting, dispensing, etc.

Specifically, FIG. 5A depicts a symmetric metal bead configuration in which the anode half plate 200 and the cathode half plate 300 have a metal bead of similar seal height (within tooling or manufacturing limits). Conversely, FIG. 5B depicts an asymmetric metal bead configuration in which the anode half plate 200 and the cathode half plate 300 have different metal bead heights. In both embodiments, the anode half plate and cathode half plate can have different thickness. Advantageously, the asymmetric metal bead configuration shown in FIG. 5B allows for the bipolar plate 550 to vary the respective anode and cathode subsystems individually as needed to support their respective functions. For example, in some embodiments, the anode half plate 200 is relatively thicker than the cathode half plate 300 (as shown). This type of asymmetric configuration allows for deeper anode-side protrusions in comparison to the cathode protrusions, which can better accommodate the relatively higher water flows through the anode half plate 200.

In any case, the use of two separate half plates (e.g., the anode half plate 200 and the cathode half plate 300) that can be welded or otherwise fixed or glued together in this manner greatly simplifies the manufacture of any tunnel features (refer to FIGS. 2 and 3) near headers for robust fluid flow and distribution into their respective active areas, as those features can be formed by hydroforming, stamping, machining, and/or chemical and electrochemical etching respective halves (e.g., top and bottom portions) of the tunnel features directly into the anode half plate 200 and the cathode half plate 300.

FIG. 5C depicts a cross-sectional view of region A-A of the anode half plate of FIG. 2 in accordance with one or more embodiments. As shown in FIG. 5C, the anode half plate 200 and the cathode half plate 300 are shaped to collectively define, after being joined, anode-side fluid passages 212. While shown specifically with respect to the anode half plate 200, the cathode-side fluid passages 312 can be similarly defined and all such configurations are within the contemplated scope of this disclosure.

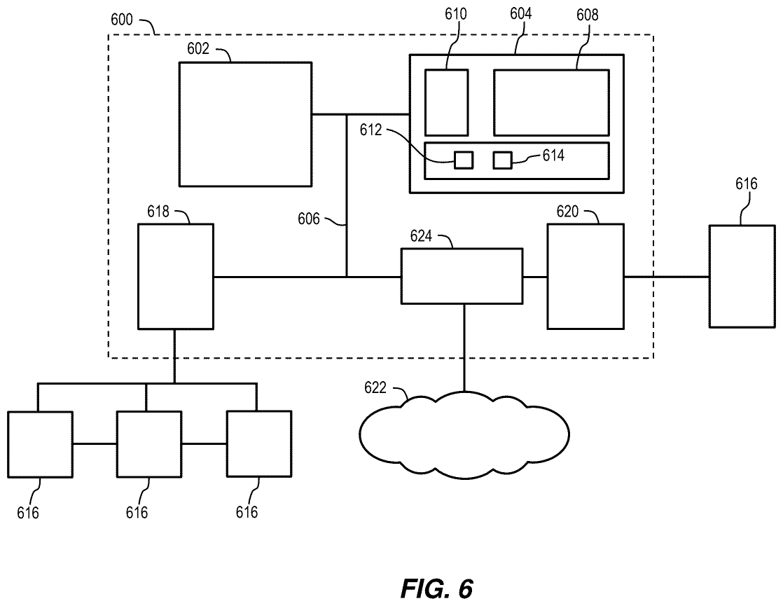

FIG. 6 illustrates aspects of an embodiment of a computer system 600 that can perform various aspects of embodiments described herein. In some embodiments, the computer system(s) 600 can implement and/or otherwise be incorporated within or in combination with an electrolyzer system, such as an electrolyzer 100 (refer to FIG. 1) fabricated from separate anode and cathode half plates (refer to FIGS. 2 and 3). For example, in some embodiments, computer system 600 can apply or receive a signal (e.g., voltage, current, etc.) to cause one or more fluids (e.g., water, hydrogen gas, etc.) into and/or out of electrolyzer 100.

The computer system 600 includes at least one processing device 602, which generally includes one or more processors or processing units for performing a variety of functions, such as, for example, any and/or all of the functions described previously herein. Components of the computer system 600 also include a system memory 604, and a bus 606 that couples various system components including the system memory 604 to the processing device 602. The system memory 604 may include a variety of computer system readable media. Such media can be any available media that is accessible by the processing device 602, and includes both volatile and non-volatile media, and removable and non-removable media. For example, the system memory 604 includes a non-volatile memory 608 such as a hard drive, and may also include a volatile memory 610, such as random access memory (RAM) and/or cache memory. The computer system 600 can further include other removable/non-removable, volatile/non-volatile computer system storage media.

The system memory 604 can include at least one program product having a set (e.g., at least one) of program modules that are configured to carry out functions of the embodiments described herein. For example, the system memory 604 stores various program modules that generally carry out the functions and/or methodologies of embodiments described herein. A module or modules 612, 614 may be included to perform functions related to any of the block diagrams described herein. The computer system 600 is not so limited, as other modules may be included depending on the desired functionality of the computer system 600. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 602 can also be configured to communicate with one or more external devices 616 such as, for example, a keyboard, a pointing device, and/or any devices (e.g., a network card, a modem, etc.) that enable the processing device 602 to communicate with one or more other computing devices. Communication with various devices can occur via Input/Output (I/O) interfaces 618 and 620.

The processing device 602 may also communicate with one or more networks 622 such as a local area network (LAN), a general wide area network (WAN), a bus network and/or a public network (e.g., the Internet) via a network adapter 624. In some embodiments, the network adapter 624 is or includes an optical network adaptor for communication over an optical network. It should be understood that although not shown, other hardware and/or software components may be used in conjunction with the computer system 600. Examples include, but are not limited to, microcode, device drivers, redundant processing units, external disk drive arrays, RAID systems, and data archival storage systems, etc.

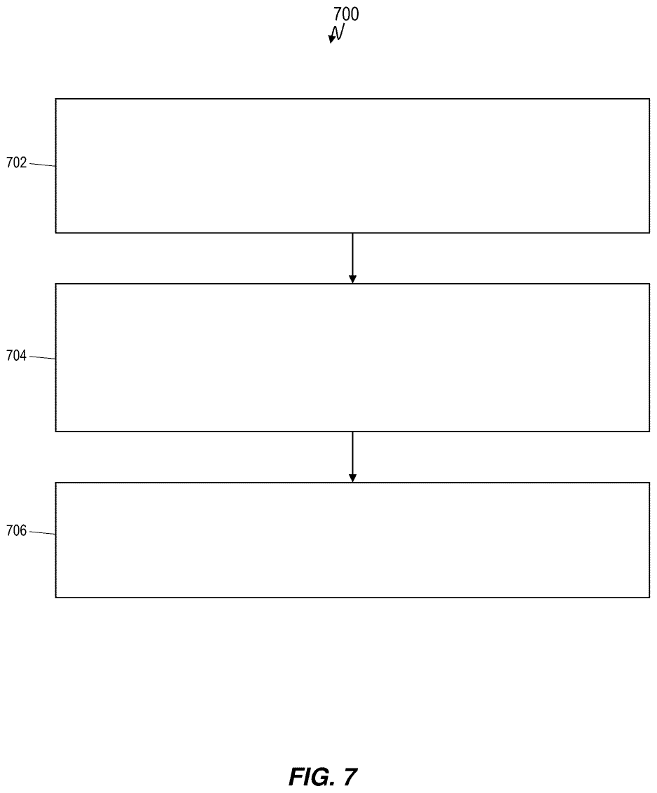

Referring now to FIG. 7, a flowchart 700 for leveraging a bipolar plate assembly for electrolysis cells is generally shown according to an embodiment. The flowchart 700 is described in reference to FIGS. 1-6 and may include additional steps not depicted in FIG. 7. Although depicted in a particular order, the blocks depicted in FIG. 7 can be rearranged, subdivided, and/or combined.

At block 702, the method includes forming an anode half plate having one or more intake headers, an anode-side flow field coupled to the one or more intake headers, and one or more outtake headers coupled to the anode-side flow field. In some embodiments, the anode-side flow field is a dimple flow field having a series of dimples.

At block 704, the method includes forming a cathode half plate coupled to the anode half plate. In some embodiments, the cathode half plate includes a cathode-side flow field and one or more outtake headers coupled to the cathode-side flow field. In some embodiments, the cathode-side flow field includes a land channel flow field having alternating lands and channels. In some embodiments, the cathode-side flow field is a land channel flow field having alternating lands and channels.

At block 706, the method includes fixing the anode half plate to the cathode half plate, thereby defining a bipolar plate assembly for an electrolyzer. While not meant to be particularly limited, in some embodiments, the anode half plate and the cathode half plate are welded together to form a single bipolar plate assembly.

In some embodiments, the anode half plate and the cathode half plate are assembled asymmetrically such that a fluid flow in the anode half plate is rotated 90 degrees relative to a fluid flow in the cathode half plate.

In some embodiments, the anode half plate and the cathode half plate collectively define a single separator plate of the electrolyzer.

In some embodiments, the anode half plate and the cathode half plate have a same thickness.

In some embodiments, the anode half plate has a first thickness and the cathode half plate has a second thickness less than the first thickness.

In some embodiments, the intake headers and outtake headers of the anode half plate and the outtake headers of the cathode half plate are sealed from the anode-side flow field and the cathode-side flow field.

In some embodiments, anode-side tunnels couple the anode-side intake headers and the anode-side outtake headers, respectively, to the anode-side flow field.

In some embodiments, cathode-side tunnels couple the cathode-side outtake headers to the cathode-side flow field.

In some embodiments, the cathode half plate and the anode half plate are coupled via a symmetric metal bead configuration.

In some embodiments, the cathode half plate includes a first metal bead height and the anode half plate includes a second metal bead height different than the first metal bead height.

In some embodiments, the intake and outtake headers of cathode half plate and anode half plate are sealed using an elastomer bead.

In some embodiments, the method includes forming bead shape protrusions on headers of the anode half plate. In some embodiments, the method includes forming bead shape protrusions on headers of the cathode half plate. In some embodiments, the bead shape protrusions on the anode half plate are joined to the bead shaped protrusions on the cathode half plate to thereby form a bead seal.

In some embodiments, the anode half plate has bead shape protrusions around the anode side intake headers and anode side outtake headers forming seals to restrict fluid flow. In some embodiments, the cathode half plate has bead shape protrusions around the cathode side outtake headers forming seals to restrict fluid flow.

In some embodiments, an elastomeric material is applied on the bead shape protrusion of the anode half plate and the cathode half plate.

In some embodiments, the bead shape protrusions on the anode half plate and the cathode half plate align to provide a sealing function.

In some embodiments, heights of the anode half plate and cathode half plate bead shape protrusions are asymmetric. In some embodiments, a height of the bead shape protrusion(s) of the anode half plate can be higher than the bead shape protrusion(s) of the cathode half plate. In some embodiments, the bead shape seals on both cathode half side and anode half side are made only of elastomer.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A bipolar plate assembly for an electrolyzer, the bipolar plate assembly comprising:
an anode half plate comprising one or more anode-side intake headers, an anode-side flow field coupled to the one or more anode-side intake headers, and one or more anode-side outtake headers coupled to the anode-side flow field, the anode-side flow field comprising a dimple flow field having a series of dimples; and
a cathode half plate coupled to the anode half plate, the cathode half plate comprising a cathode-side flow field and one or more cathode-side outtake headers coupled to the cathode-side flow field, the cathode-side flow field comprising a land channel flow field having alternating lands and channels.

2. The bipolar plate assembly of claim 1, wherein the anode half plate and the cathode half plate are assembled asymmetrically such that a fluid flow in the anode half plate is rotated 90 degrees relative to a fluid flow in the cathode half plate.

3. The bipolar plate assembly of claim 1, wherein the anode half plate and the cathode half plate collectively define a single separator plate of the electrolyzer.

4. The bipolar plate assembly of claim 3, wherein the anode half plate and the cathode half plate have a same thickness.

5. The bipolar plate assembly of claim 3, wherein the anode half plate has a first thickness and the cathode half plate has a second thickness less than the first thickness.

6. The bipolar plate assembly of claim 1, wherein the one or more anode-side intake headers and the one or more anode-side outtake headers of the anode half plate and the one or more cathode-side outtake headers of the cathode half plate are sealed from the anode-side flow field and the cathode-side flow field.

7. The bipolar plate assembly of claim 6, further comprising anode-side tunnels coupling the one or more anode-side intake headers and the one or more anode-side outtake headers, respectively, to the anode-side flow field.

8. The bipolar plate assembly of claim 6, further comprising cathode-side tunnels coupling the one or more cathode-side outtake headers to the cathode-side flow field.

9. The bipolar plate assembly of claim 1, wherein the cathode half plate and the anode half plate are coupled via a symmetric metal bead configuration.

10. The bipolar plate assembly of claim 1, wherein the cathode half plate comprises a first metal bead height and the anode half plate comprises a second metal bead height different than the first metal bead height.

11. The bipolar plate assembly of claim 1, where in the one or more anode-side intake headers and the one or more cathode-side outtake headers of cathode half plate and anode half plate are sealed using an elastomer bead.

12. A method comprising:
forming an anode half plate comprising one or more anode-side intake headers, an anode-side flow field coupled to the one or more anode-side intake headers, and one or more anode-side outtake headers coupled to the anode-side flow field, the anode-side flow field comprising a dimple flow field having a series of dimples;
forming a cathode half plate coupled to the anode half plate, the cathode half plate comprising a cathode-side flow field and one or more cathode-side outtake headers coupled to the cathode-side flow field, the cathode-side flow field comprising a land channel flow field having alternating lands and channels; and
fixing the anode half plate to the cathode half plate, thereby defining a bipolar plate assembly for an electrolyzer.

13. The method of claim 12, wherein the anode half plate and the cathode half plate are assembled asymmetrically such that a fluid flow in the anode half plate is rotated 90 degrees relative to a fluid flow in the cathode half plate.

14. The method of claim 12, wherein the anode half plate and the cathode half plate collectively define a single separator plate of the electrolyzer.

15. The method of claim 14, wherein the anode half plate and the cathode half plate have a same thickness.

16. The method of claim 14, wherein the anode half plate has a first thickness and the cathode half plate has a second thickness less than the first thickness.

17. The method of claim 12, wherein the one or more anode-side intake headers and the one or more anode-side outtake headers of the anode half plate and the one or more cathode-side outtake headers of the cathode half plate are sealed from the anode-side flow field and the cathode-side flow field.

18. The method of claim 17, further comprising:
forming anode-side tunnels coupling the anode-side intake headers and the anode-side outtake headers, respectively, to the anode-side flow field; and
forming cathode-side tunnels coupling the one or more cathode-side outtake headers to the cathode-side flow field.

19. The method of claim 12, wherein the cathode half plate and the anode half plate are coupled via a symmetric metal bead configuration.

20. The method of claim 19, wherein the cathode half plate comprises a first metal bead height and the anode half plate comprises a second metal bead height different than the first metal bead height.
